(19) United States
(12) Patent Application Publication
(10) Pub. No.: US 2025/0189654 A1
(43) Pub. Date: Jun. 12, 2025

(54) GROUND MOVING TARGET INDICATOR DETECTION SYSTEM

(71) Applicant: Raytheon Company, Arlington, VA (US)

(72) Inventors: Ron L. Levin, EL SEGUNDO, CA (US); Maximilian Lester-Wilhelm Hushahn, LOS ANGELES, CA (US)

(21) Appl. No.: 18/975,911

(22) Filed: Dec. 10, 2024

Related U.S. Application Data
(60) Provisional application No. 63/608,632, filed on Dec. 11, 2023.

(51) Int. Cl. G01S 13/524; G01S 7/282; G01S 7/292; G01S 7/295; G01S 13/89

(52) U.S. Cl. CPC G01S 13/5248; G01S 7/282; G01S 7/2927; G01S 7/295; G01S 13/89

(57) ABSTRACT

A moving target indicator radar system can include a radar transceiver. The system can further include processing circuitry. The processing circuitry can provide a command to move an antenna beam in an azimuth direction. The processing circuitry can further control the radar transceiver to transmit a series of pulses throughout antenna beam motion such that the series of pulses are assembled into Coherent Processing Intervals (CPIs) and such that for a possible target, sequential sets of CPIs are combined covering at least a 3 dB portion an azimuth beam. The processing circuitry can further detect at least one moving target in at least one CPI. Other apparatuses and methods are also described.

### CLAIM OF PRIORITY

This patent application claims the benefit of priority to U.S. Provisional Application Ser. No. 63/608,632, filed Dec. 11, 2023, which is incorporated by reference herein in its entirety.

### TECHNICAL FIELD

The present disclosure generally relates to moving target detection, and more specifically, to clustering algorithms for use on radar target detection systems.

### BACKGROUND

Moving target indicator (MTI) systems use radar to detect moving objects and to distinguish moving objects from stationary objects. Ground MTI systems can be implemented on aerial systems to detect moving objects on the ground and to provide outputs such as maps indicating location and relative position of moving objects. MTI systems are processing-intensive and can suffer from deficiencies in the range at which moving objects can be detected.

### BRIEF DESCRIPTION OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 illustrates a moving target indicator (MTI) radar scan across surveilled territory.

FIG. 2 illustrates a moving target indicator radar system according to example embodiments.

FIG. 3A illustrates azimuth scans according to available systems.

FIG. 3B illustrates azimuth scans according to example embodiments.

FIG. 4 illustrates Swerling distributions plotted for a target that has a mean RCS of 1 m².

FIG. 5 illustrates parallel processing according to example embodiments.

FIG. 6 illustrates a group of CPIs and respective CPI times in accordance with some embodiments.

FIG. 7 illustrates two-dimensional clustering in accordance with some embodiments.

FIG. 8 illustrates three-dimensional clustering in accordance with some embodiments.

FIG. 9 is a flow chart of an example method according to embodiments.

FIG. 10 is a diagrammatic representation of a machine in the form of a computer system within which a set of instructions may be executed to cause the machine to perform any one or more of the methodologies discussed herein, according to some examples.

### DETAILED DESCRIPTION

Moving target indication (MTI) systems use radar to distinguish moving objects from stationary objects. Some early MTI systems used an acoustic delay line to store pulses one at a time and send data to a display on each pulse. However, these systems were subject to noise and only performed adequately in the presence of strong signals. Later systems performed digital signal processing. These systems were more robust in the presence of noise but were constrained in detection range and were computationally expensive.

The systems and techniques described herein address these and other concerns by performing parallel processing of data and by avoiding expensive inter-processor communication to reduce computation expense and complexity. Furthermore, techniques described herein provide enhanced beam sweeping algorithms to improve detection range.

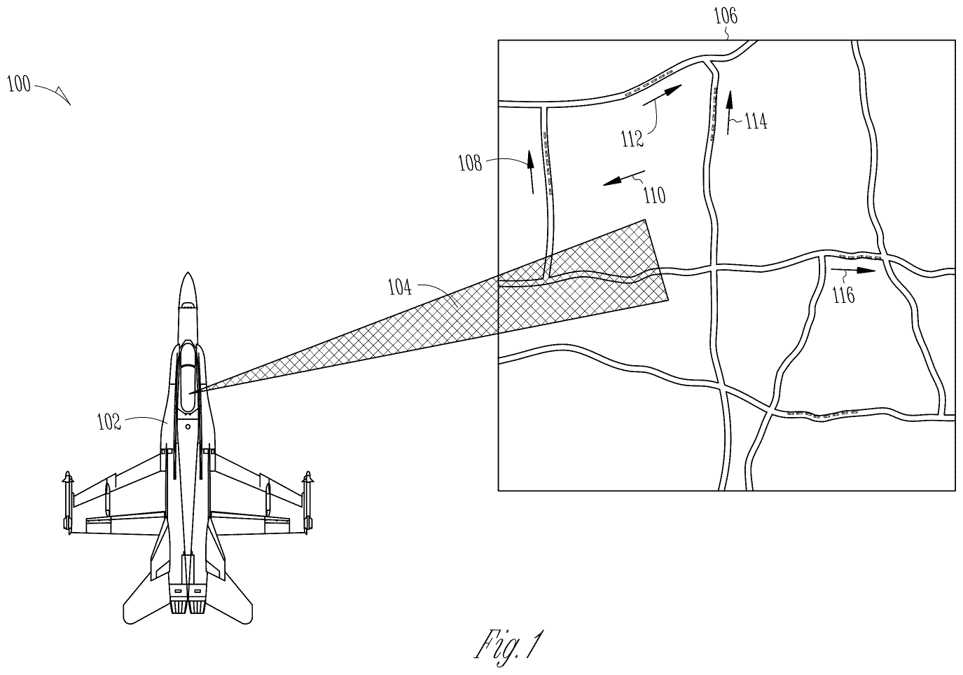

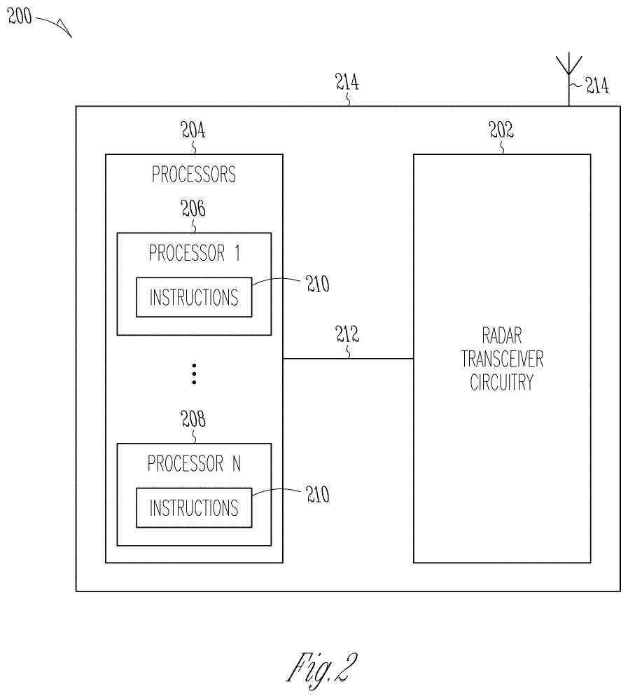

FIG. 1 illustrates a moving target indicator (MTI) radar scan 100 across a surveilled territory. In the illustrated example, a detection system can be included in an airborne radar device 102, e.g., an airplane, satellite, missile system, etc. A beam 104, e.g., a radar beam, can move in a sweeping direction from, for example, the front of the airborne radar device 102 to the back, although embodiments are not limited thereto. The beam 104 can remain on a spot on the ground for a period of time (e.g., one second) before sweeping to a next azimuthal position. As moving objects are detected, according to embodiments described below with reference to FIGS. 2-10, a map 106 can be developed to display moving targets or groups 108, 110, 112, 114, 116 of moving targets.

FIG. 2 illustrates a moving target indicator radar system 200 that could be included on the airborne radar device 102 or at a remote location to implement techniques according to some examples.

The system 200 can include a radar transceiver 202 for transmitting and receiving radar beams (e.g., beam 104 (FIG. 1)). The system 200 can include processing circuitry 204. In an example, the processing circuitry 204 may include a processor 206 and a processor 208 that execute the instructions 210. The processing circuitry 204 can include any number of processors similar to processor 206 and processor 208. The instructions 210 may cause the system 200 to execute any one or more of the methods described herein. The term “processor” is intended to include multi-core processors that may comprise two or more independent processors (sometimes referred to as “cores”) that may execute instructions contemporaneously. Although FIG. 2 shows multiple processors within processing circuitry 204, systems described herein may include a single processor with multiple cores (e.g., a multi-core processor), multiple processors with a single core, multiple processors with multiples cores, or any combination thereof.

Referring still to FIG. 2, the processing circuitry 204 can be coupled to the radar transceiver 202 through a bus or interconnect 212. The processing circuitry 204 can provide a command to move an antenna 214 beam (e.g., beam 104 (FIG. 1) in an azimuth direction as shown in FIG. 1. The processing circuitry 204 can therefore be used to implement the azimuth beam scan and other operations as described below.

### Azimuth Beam Scan

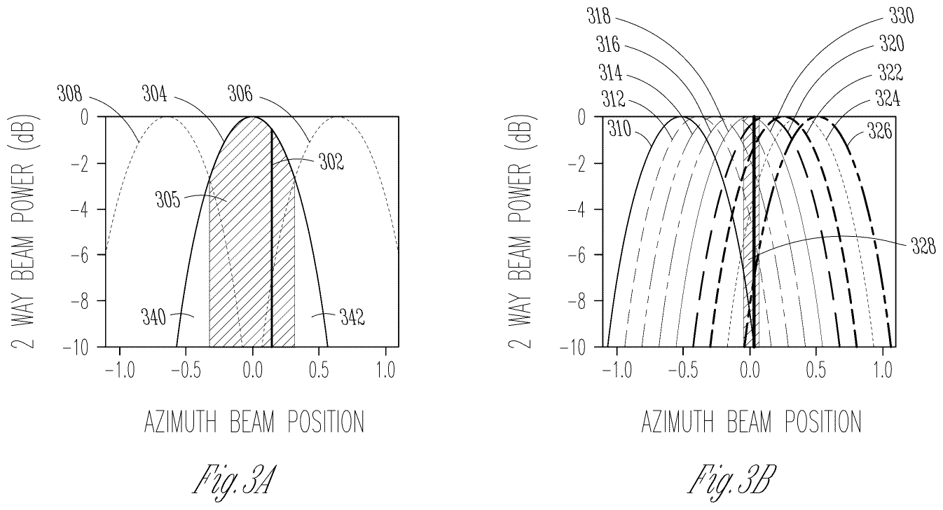

In some available systems, a high gain antenna is used to illuminate a beam in the azimuth direction as seen in FIG. 3A. Target 302 in dwell 304 can be detected. In the context of example systems and methods described herein, a “dwell” can include a number of successive coherent processing intervals (CPIs) at which an antenna is aimed at the same place on the ground. Some example dwells can be on the order of about five CPIs although systems are not limited thereto. CPIs can use unique center frequencies to decorrelate speckle and to provide independent realizations of the Swerling 1 radar cross section (RCS) fluctuation model. The high gain antenna greatly improves the detection performance of the radar.

Still referring to FIG. 3A, target 302 can be scanned a number of times (e.g., 5 times), once for each CPI in the dwell 304. The area 305 that is illuminated indicates where beam power is at least 3 dB, and any targets outside area 305 will not be processed for that dwell and will not be detected in that dwell. Furthermore, in available systems, the detection of a particular target (e.g., target 302) is solely based on the five (or other number of) CPIs in that dwell, and the part of the radar energy that is outside of dwell 304 does not get cross-correlated with information captured in a next dwell (e.g., dwell 306 or dwell 308). Therefore, some targets may be missed entirely (when insufficient target energy is accumulated in the 3 dB illumination area of any dwell 304, 306, 308) and some information may be lost for other targets due to the lack of cross-correlation with information from other dwells.

In contrast, FIG. 3B illustrates azimuth scans according to example embodiments. As seen in FIG. 3B, dwells 310, 312, 314, 316, 318, 320, 322, 324, 326 overlap to a greater extent compared to in FIG. 3A. The gain on each illumination 328 is between 0.5 dB and 9 dB below maximum which can improve detection range. The beam (e.g., beam 104 (FIG. 1)) is moved continuously over a same azimuthal range (e.g., azimuth beam position is swept over a same or similar range but with a greater number of dwells). While nine dwells 310, 312, 314, 316, 318, 320, 322, 324, 326 are shown, a greater or smaller number of dwells can be provided.

A target 330 can be illuminated in a plurality of dwells 310, 312, 314, 316, 318, 320, 322, 324, 326 and at different beam powers including those below 3 dB (in contrast to available systems wherein no signal would be accumulated outside the 3 dB illumination area 305). Information can be collected regarding the target 330 at each dwell 310, 312, 314, 316, 318, 320, 322, 324, 326 where the target 330 is detected. For example, target 330 is illuminated in dwell 310 at about 9 dB, in dwell 312 at about 6 dB, and in dwell 318 at about 0.5 dB, among other illuminates. As can be seen, some illuminations of the target 330 may be made with a lower power than other illuminations; however, the Swerling 1 model of RCS fluctuations indicates the RCS on any CPI might be very large. The more independent illuminations on a target 330, the greater is the probability of receiving a very strong illumination including important or additional information on the target 330.

Processing the information from the edges of the main lobe in accordance with techniques of embodiments can provide substantial improvements in signal-to-noise ratio (SNR). For example, referring again to FIG. 3A, detection of a target would not be made in dwell 304 at the edges of the main lobe, e.g., in areas 340, 342 using available systems. An opportunity would be missed to gather information from dwell 304 for any targets in areas 340, 342. In contrast, in FIG. 3B according to example embodiments, more detections could be made because of the increased number of dwells and because detections signal could be accumulated over a wider range of the main lobe of an azimuth beam. For example, detection could be accumulated beyond the 3 dB edge of each azimuth beam, or up to the entirety of an azimuth beam (or “null-to-null”).

The density of probability of the RCS (P(σ)) is given by the Raleigh distribution:

$$P ( σ ) = \frac{1}{{σ}_{mean}} {e}^{( \frac{- σ}{{σ}_{mean}} )} \qquad ( 1 )$$

where σₘₑₐₙ is the arithmetic average of all values of RCS of the target (or reflecting object).

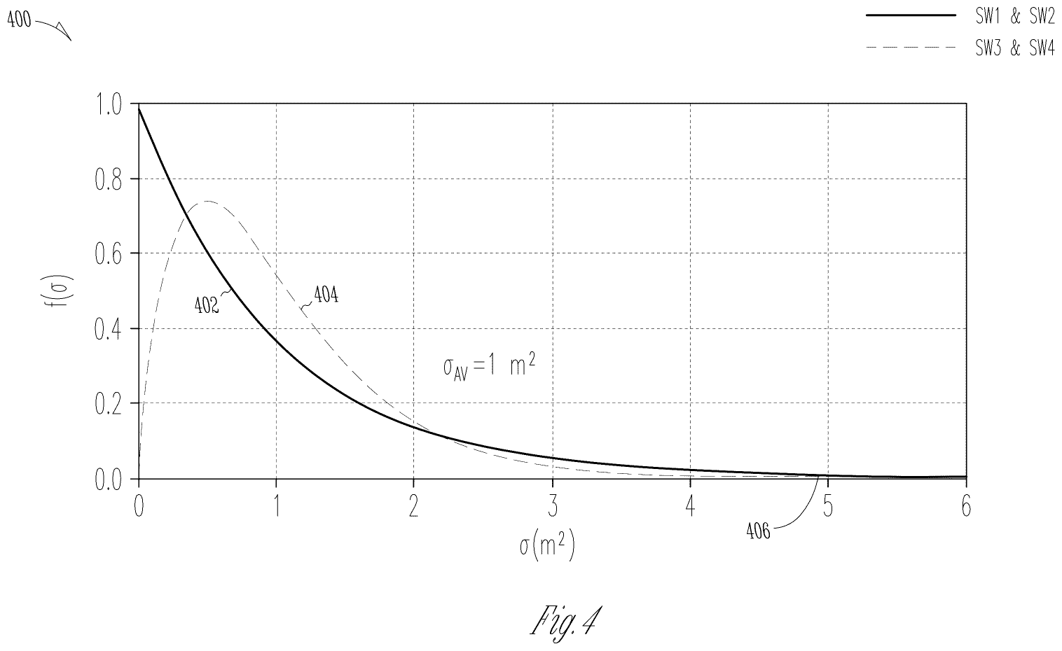

FIG. 4 illustrates Swerling distributions 400 plotted for a target that has a mean RCS of 1 m². The majority of realizations 402 are less than 1 m². However, a few realizations 404 have an RCS much larger than 1 m². Some realizations 406 can 5 m² RCS. SW1 (also referred to as Swerling I) describes a case in which a target's velocity is low compared to the observation time, and therefore the target can be considered to be non-moving. The motion of the target is therefore seen scan-to-scan and not intra-scan. SW2 (Swerling II) is similar to SW1 except RCS values change pulse-to-pulse rather than scan-to-scan, which can occur with high-speed targets.

SW3 (Swerling III) is a model in which the RCS varies according to a chi-squared probability density function with four degrees of freedom (m=2). This PDF approximates an object with one large scattering surface with several other small scattering surfaces. SW3 is the analog of SW1, considering the case where the RCS is constant through a single scan. SW4 (Swerling IV) is similar to SW3 but with the RCS varying pulse-to-pulse rather than from scan-to-scan.

### Front-End CPI-by-CPI Processing

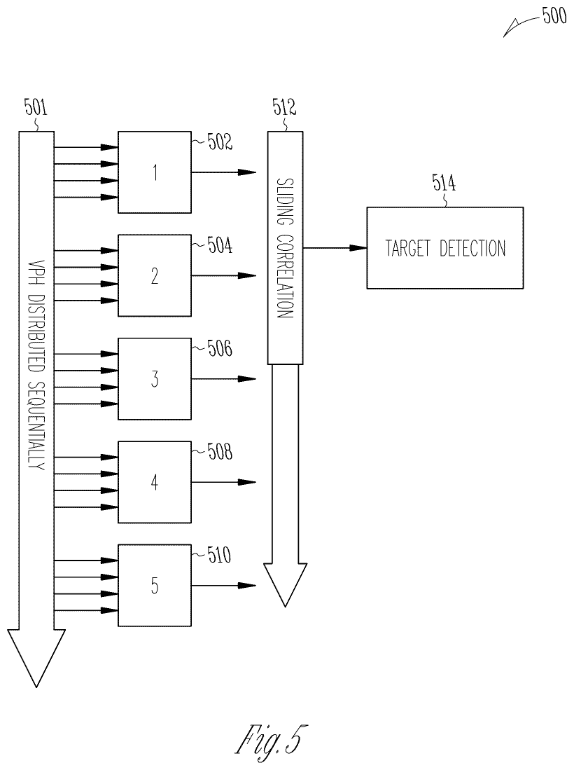

Data captured in each CPI is processed using parallel processing, and FIG. 5 illustrates parallel processing 500 according to example embodiments. Recent memory and processing technologies have increased the amount of memory that can be made available to processors. Accordingly, as seen in FIG. 5, video phase history (VPH) data 501 for an entire CPI is provided to each of processing elements 502, 504, 506, 508, 510 to take advantage of the amount of memory available for each of processing elements 502, 504, 506, 508, 510. Processing elements 502, 504, 506, 508, 510 can be similar to processing circuitry 204 and processors 206, 208.

Data for one CPI is provided to a first processing element of processing elements 502, 504, 506, 508, 510, a next CPI is provided to a second processing element of processing elements 502, 504, 506, 508, 510, etc. The processing elements 502, 504, 506, 508, 510 each convert VPH 501 into a range-Doppler map for a single CPI. Computational power and inter-processor communication is reduced because range-Doppler maps can be produced for each CPI without the need for information from other CPIs provided to the other processing elements 502, 504, 506, 508, 510.

The front-end processing of CPIs can be assigned “Round Robin” to processing elements 502, 504, 506, 508, 510. While five processing elements 502, 504, 506, 508, 510 are shown, system 500 can include any number of processing elements.

Processing elements 502, 504, 506, 508, 510 can convert VPH 501 into range-Doppler maps in one operation by providing a matched filter and deconvolution for the transmitted waveform. Each pulse can be interpolated so that the pulse center is at Central Reference Point (CRP). In a subsequent operation, two-dimensional fast Fourier Transform can be performed to produce a range-Doppler map using a two-dimensional FFT. Accordingly, a range-Doppler map is generated for each CPI. As processing is done on the range-Doppler maps (as describe below) maps can be deleted from the corresponding processing elements 502, 504, 506, 508, 510 so that those processing elements 502, 504, 506, 508, 510 can be used to generate subsequent range-Doppler maps as seen at block 512. CPI target detections can be provided to processing circuitry 514 and target lists can be generated as described in more detail below.

### Forming a List of CPI Detections

Processing elements 502, 504, 506, 508, 510 form a list of CPI targets based on the range-Doppler map stored in respective processing element 502, 504, 506, 508, 510. The energy in range-Doppler maps may comprise energy from moving targets and Gaussian thermal white noise, among other energy sources. The processing elements 502, 504, 506, 508, 510 can detect which pixels in the range-Doppler map include moving targets by detecting pixels that have a higher energy relative to surrounding pixels. A list of possible targets is generated to be processed according to “clustering” algorithms, wherein clustering algorithms can discriminate between true moving targets and thermal noise outliers as described later herein.

Detection thresholds can be set to a numerical value (e.g., 5 dB above noise) based on historical detection data. A target list can include information regarding a target such as: 1.) Discovery ID; 2.) CPI number and time; 3.) Range; 4.) Range Rate; 5.) SNR; 6.) Latitude and Longitude and other parameters. Once a list is generated, the respective range-Doppler map can be deleted from the respective processing element 502, 504, 506, 508, 510 and that processing element 502, 504, 506, 508, 510 can be provided to the next CPI's data to generate another range-Doppler map.

### Replication of Detections to Ambiguous Hypotheses

Referring still to FIG. 5, a respective processing element 502, 504, 506, 508, 510 can perform a replication of the generated list. This replication is done by creating list entries corresponding to each possible detection adjusted by ambiguous range and Doppler locations. For example, given a list entry A with a range X and an azimuth Y, the respective processing element 502, 504, 506, 508, 510 can generate replicated entries based on A having range X±an ambiguity value and an azimuth Y±an ambiguity value. Ambiguity values are generated as described below. These replicated entries are referred to later herein as “hypotheses.”

Range ambiguity can be defined as the half the distance that light travels in a pulse repetition interval (PRI), wherein a PRI is a time interval between two adjacent pulses and a pulse repetition frequency (PRF) is the rate that pulses repeat per second. Every detection in a list could have come from a stated range± an integer number of range ambiguities. In examples, five range ambiguities can be generated, although embodiments are not limited thereto.

Doppler has a similar ambiguity problem. The Doppler frequency detected could be caused by a target at velocities that alias to the detected frequency. These ambiguous frequencies are the detected frequency plus multiples of the PRF. All ambiguous velocities are considered up to±the maximum detectible velocity. In examples, three Doppler ambiguities can be generated, although embodiments are not limited thereto.

Each processing element 502, 504, 506, 508, 510 therefore can generate list members and replicated list members, with each list member being replicated by the number of ambiguous ranges times the number of ambiguous velocities (five times three in the example above). Every ambiguous range within the vertical beam illumination can hypothetically be the “true” target range. In some systems, each “bar” in the scan has a minimum and maximum range which approximates the vertical illumination.

After all detections have been replicated, hypotheses in the final list are assigned a unique ID. The unique ID will not be reused until a complete azimuth scan has been completed. Each processing element 502, 504, 506, 508, 510 can output a respective list of hypothetical detections to separate processing circuitry and analyzed using clustering as described below.

### Clustering and Output

As the detection lists (and corresponding hypotheses) become available, the lists are examined in groups of contiguous CPIs by processing circuitry 514 to determine which hypotheses are correct (true) and which are incorrect (false), and to delete incorrect hypotheses from the list. In some embodiments, every group can be examined regardless of overlap with neighboring groups.

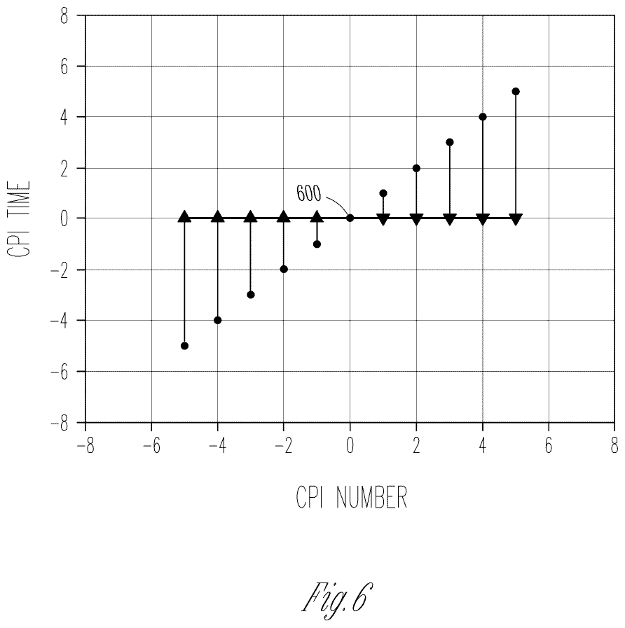

FIG. 6 illustrates a group of CPIs and respective CPI times in accordance with some embodiments. In the example illustrated in FIG. 6, timing for eleven contiguous CPIs is shown (and eleven CPIs may be examined per group); however, embodiments are not limited thereto. Each CPI has a corresponding center time. The CPIs in each group were collected within a short time of each other, and processing circuitry 514 can determine the median center time at time 600, which will thereafter be set as the center time for of all CPIs of the group. The range of each hypothetical detection is propagated to the range it should have had at the center time. This is done by multiplying the hypothetical range rate by the difference between the CPI time and the center time. For this short interval of time the target has a good chance of moving at a constant velocity. This part of the algorithm is sometimes called track-before-detect.

Every hypothetical target has a different CPI time, a different range, and a different range rate. Aligning the hypothetical target positions at the center time can be similar focusing the hypothetical targets at that time. The “true” hypotheses will focus into a cluster while the incorrect ones will not, allowing the processing circuitry 514 to distinguish incorrect hypotheses from correct hypotheses.

True target hypotheses should cluster in three dimensions: range, range rate, and azimuth angle, with the most important dimension being range because for every hypothesis, range has the highest precision. Next in importance is range rate, or Doppler, because under most system parameters, Doppler is almost as precise as range. The least precise dimension is the azimuth angle, commonly believed to be precise up to 10% of a beam width. However, even at this low precision it is valuable to include azimuth in the clustering process. The examination of azimuth can eliminate false alarms.

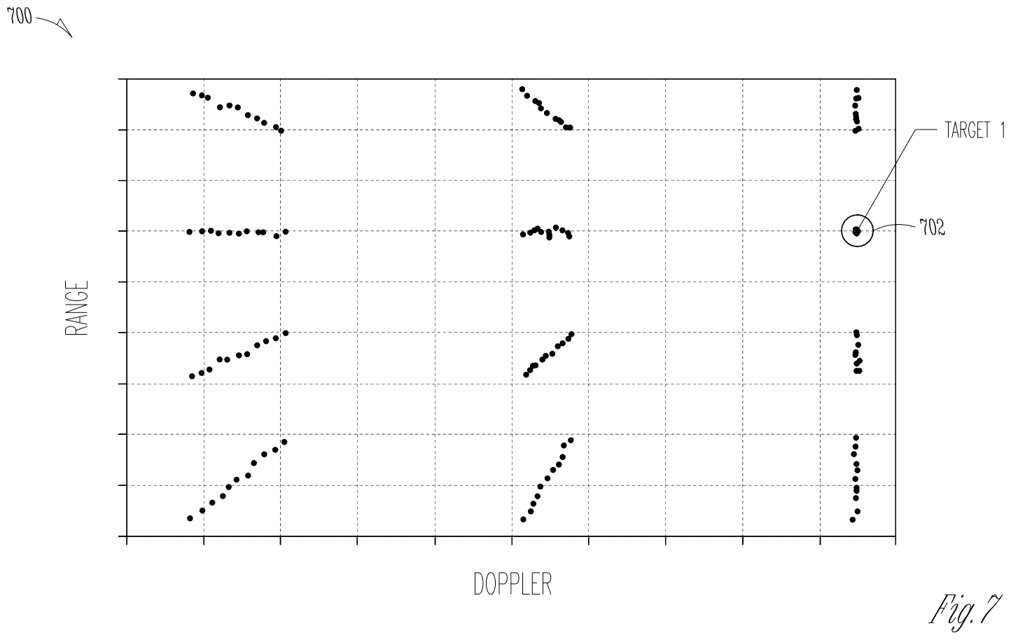

FIG. 7 illustrates two-dimensional clustering 700. In FIG. 7, the true position of the target (TARGET 1) is shown with hypotheses clustered at 702. Other hypotheses, shown by other dots besides 702, are not clustered and accordingly are “false.”

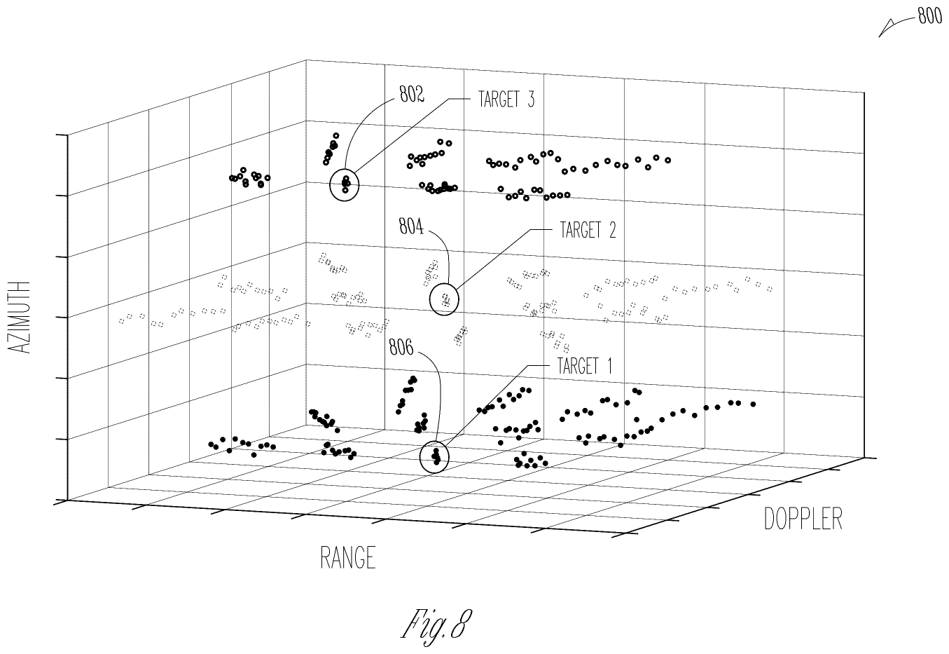

Clustering can also be done in three dimensions in various embodiments. FIG. 8 illustrates three-dimensional clustering 800 in accordance with some embodiments.

In FIG. 8, azimuth is observed in addition to range and Doppler. In this scenario, there are there are three targets 802, 804, 806, which all arrive at different azimuths. Hypotheses for each target 802, 804, 806 are shown near the targets (TARGET 3, TARGET 2, TARGET 1); respectively, at about the same azimuth but at different ranges/Doppler values.

The processing circuitry 514 calculates the azimuth for each hypothetical detection from the airborne radar device 102 location at the center of the N CPIs and the latitude and longitude for each detection hypothesis. Clustering is done by finding the region in three-dimensional space that has the largest SNR summed across the clustered hypotheses. The strongest cluster is the first cluster that the processing circuitry 514 considers for the final detection list. The final detection list consists of the hypothesis IDs that made up the cluster. Next, the processing circuitry considers the next-highest scoring cluster, etc.

The clustering of hypotheses in three dimensions “disambiguates” the ground MTI detections in both range and Doppler. By clustering in three dimensions, systems, and apparatuses according to embodiments can also verify that a cluster has a consistent target azimuth.

Subsequent to clustering, related hypotheses can be removed from hypothesis lists. The known effects of the target responsible for each cluster are removed, meaning that any hypothesis in the list that is a brother (different range or Doppler ambiguity) of an element that is part of the cluster is removed. If nine hypotheses fall into a cluster, each could have twenty brother hypotheses (180 total). Removal of these 180 hypotheses makes the picture clearer for the identification of subsequent clusters. This process continues until no more clusters can be found with a total energy above a threshold value. The threshold can be range dependent to reject low RCS targets at short range. In some examples, the threshold SNR will be about 5 dB.

In some examples, the results for each group of CPIs is not reported immediately. Instead, results are held for additional groups of CPIs to help in amalgamation of overlapping clusters. The clusters for the last few groups are searched for overlapping members. If two clusters contain the same “unique ID” the clusters are merged. The union of members from both sets is listed as a single cluster. This merged cluster replaces the two clusters that overlapped. Bright targets are often seen for many CPIs. This step in the algorithm consolidates all the energy into a single detection.

After cluster consolidation, each cluster can consist of a list of hypothesis IDs. The parameters from the original hypotheses associated with the IDs can be combined to provide a single set of parameters for each final detection. The final detection SNR can be calculated as the sum of the SNR values from the hypotheses that are in the cluster. These are the same values that were used to determine if the raw detections exceeded a threshold.

Many parameters can be estimated using the SNR weighted average of values from the hypotheses. Example parameters include: time of validity; geodetic location (Latitude, Longitude and Altitude); and range rate relative to the radar. Time of validity can be useful for subsequent tracking either in the scan 100 or as part of subsequent exploitation processing. Location and range rate parameters can be derived with auxiliary or navigation data. Example data can include line of sight velocity relative to the ground, slant range or azimuth relative to north.

Detections can be formatted for output (e.g., to a display), sent internally to a tracker, etc. or any combination thereof. After a cluster is reported or displayed, or some timeframe after reporting, memory associated with each cluster and cluster unique IDs can be deallocated. This bounds the hypothesis list at a modest size in steady state. If a beam azimuth or range changes, the lists of hypotheses can be cleared and the accumulation of target evidence can be re-initiated. Some conditions that may cause this clearing and re-scanning can include change in antenna elevation, the airborne radar device 102 changes direction, etc.

In some radar systems or sensing systems, ground MTI data can be captured simultaneously in wide swaths of azimuths. In at least these systems, antenna scanning is not performed and there is not a need to analyze groups of CPIs together. Instead, each CPI is analyzed to build range-Doppler map/s and to generate a list of initial detections for each CPI. Replication is performed as described above and a pipeline of hypothesis lists is built that remains in memory for a length of time that a moving object is likely to stay at constant velocity. This can range on the order of 2-5 seconds for some moving vehicles on the ground or on the order of several minutes for ships at sea, for example. The hypotheses are clustered based on the pipeline the cluster belongs too, and azimuth may be the more important dimension (rather than range or Doppler).

Because these types of systems simultaneously illuminate in many directions at once, clustering is not based on interval of illumination. The duration of a pipeline can be based on an analysis of the propagation of hypotheses to the “center time.” The longer the propagation interval the higher the probability of detection. If the length of the pipeline is too long, however, random acceleration of targets will cause hypotheses to lose focus when propagated to the center time. These types of systems can also maintain different pipeline lengths simultaneously to optimize the system for targets of different maneuverability. The length of the pipeline is not constrained by any particular beam scan.

### Example Method

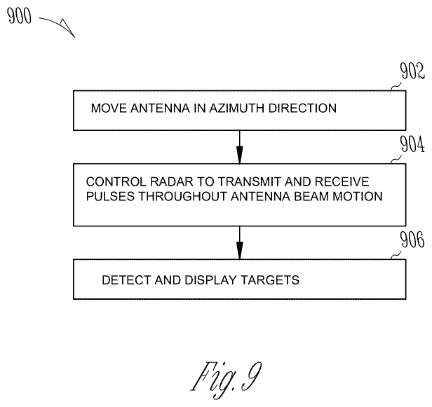

FIG. 9 is a flow chart of an example method 900 according to embodiments. The method 900 can be performed by processors (e.g., processing circuitry 204 (FIG. 4) which can include a plurality of processing cores or other processing elements (FIG. 5) or processing circuitry 514 (FIG. 5)).

Method 900 can begin with operation 902 with controlling an antenna (e.g., antenna 214 (FIG. 2)) in an azimuthal direction.

Method 900 can continue with operation 904 with controlling a radar transceiver (e.g., radar transceiver 202 (FIG. 2)) to transmit a series of pulses throughout antenna beam motion such that the series of pulses are assembled into Coherent Processing Intervals (CPIs). For any possible target, sequential sets of CPIs can be combined covering at least 50% of an azimuth beam. Furthermore, as described with reference to FIG. 3B, the sequential sets can cover the azimuth beam null-to-null, or any portion of the azimuth beam greater than or equal to the 3 dB beamwidth of the azimuth beam.

The method 900 can continue with operation 906 with detecting and displaying targets according to algorithms described above. For example, the method 900 can include steering the beam such that the beam moves to a new azimuth with each CPI. As discussed with reference to FIG. 5, each CPI can be processed independently and simultaneously on each of plurality of a set of processors (e.g., processing elements 502, 504, 506, 508, 510). A map can be generated at each processor to include a set of target indications. The method 900 can include generating a list of detections from the map, and then removing the map from processor memory after generating the list. The list can include coordinate information, range information, and CPI information, etc. for each map.

Hypotheses can be generated for each detection in the list based on range and Doppler ambiguities. The hypotheses can be clustered in two or three dimensions to determine which hypotheses are true and which should be removed from the list of hypotheses. Once the true hypotheses are detected, the corresponding targets can be displayed, stored in a tracker, etc.

By implementing method 900 or similar methods in systems according to embodiments described above, radar detection system operators may achieve an increased detection range. Computer and processing power can be made more efficient through parallelization and through the reduction in inter-processor communication to achieve the same or better number of detections. Sparsification is achieved by reducing the amount of data in radar images to a list of potential targets and hypothetical targets, with removal of the radar images and lists from memory as soon as the accompanying data has been handled.

### Additional Machine Components

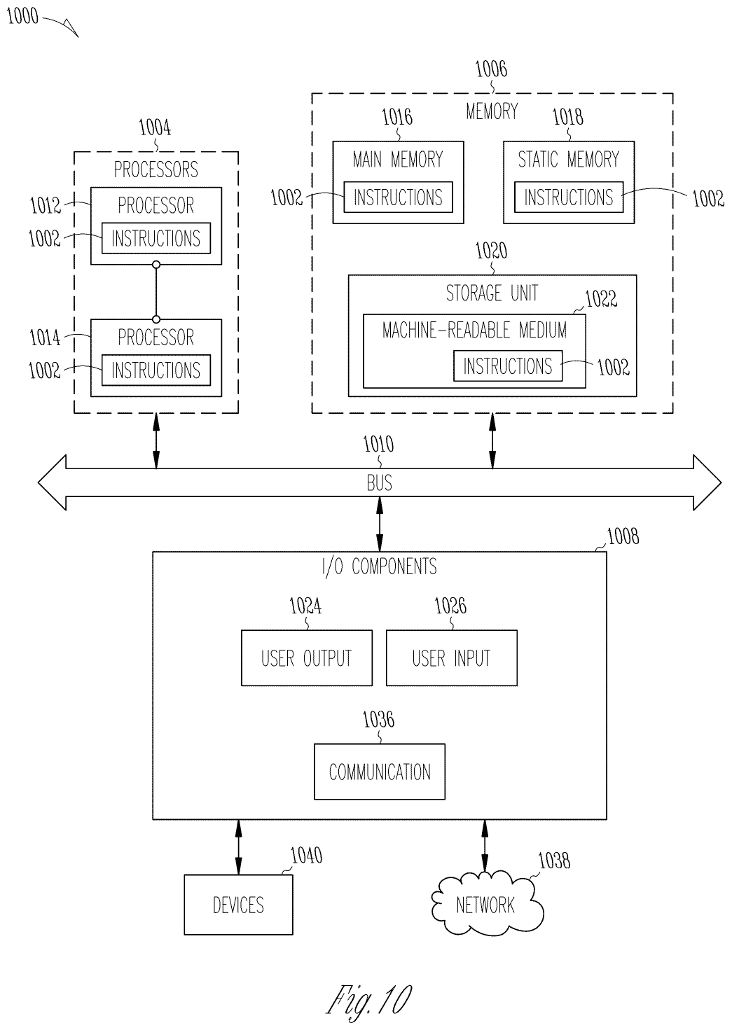

FIG. 10 is a diagrammatic representation of the machine 1000 in which example embodiments can be implemented. The machine 1000 can include processing circuitry 1004, which can be similar in structure and function to processing circuitry 204 (FIG. 2). For example, the processing circuitry 1004 can include a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof.

The instructions 1002 may cause the system 1000 to execute any one or more of the methods described herein. The machine 1000 may operate as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. Further, while a single machine 1000 is illustrated, the term “machine” shall also be taken to include a collection of machines that individually or jointly execute the instructions 1002 to perform any one or more of the methodologies discussed herein. The machine 1000, for example, may comprise any of the processors or processing elements described above for processing CPIs to detect moving targets, for example, vehicles or other objects moving on the ground or at sea, for example.

The machine 1000 may include memory 1006, and input/output I/O components 1008, which may be configured to communicate with each other via a bus 1010.

The memory 1006 includes a main memory 1016, a static memory 1018, and a storage unit 1020, both accessible to the processors 1004 via the bus 1010. The main memory 1006, the static memory 1018, and storage unit 1020 store the instructions 1002 embodying any one or more of the methodologies or functions described herein. The instructions 1002 may also reside, completely or partially, within the main memory 1016, within the static memory 1018, within machine-readable medium 1022 within the storage unit 1020, within at least one of the processors 1004 (e.g., within the processor's cache memory), or any suitable combination thereof, during execution thereof by the machine 1000.

The I/O components 1008 may include a wide variety of components to receive input, provide output, produce output, transmit information, exchange information, capture measurements, and so on. In various examples, the I/O components 1008 may include user output components 1024 and user input components 1026. The user output components 1024 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1026 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

Communication may be implemented using a wide variety of technologies. The I/O components 1008 further include communication components 1036 operable to couple the machine 1000 to a network 1038 or devices 1040 via respective coupling or connections. For example, the communication components 1036 may include a network interface component or another suitable device to interface with the network 1038. In further examples, the communication components 1036 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1040 may be another machine or any of a wide variety of peripheral devices (e.g., a peripheral device coupled via a USB).

The various memories (e.g., main memory 1016, static memory 1018, and memory of the processors 1004) and storage unit 1020 may store one or more sets of instructions and data structures (e.g., software) embodying or used by any one or more of the methodologies or functions described herein. These instructions (e.g., the instructions 1002), when executed by processors 1004, cause various operations to implement the disclosed examples.

The instructions 1002 may be transmitted or received over the network 1038, using a transmission medium, via a network interface device (e.g., a network interface component included in the communication components 1036) and using any one of several well-known transfer protocols (e.g., hypertext transfer protocol (HTTP)). Similarly, the instructions 1002 may be transmitted or received using a transmission medium via a coupling (e.g., a peer-to-peer coupling) to the devices 1040.

Technical effects include improved radar detection systems that can detect moving targets at increased range while using less computational power. Inter-processor communication is reduced by making use of memory on each processor to separately store detection information. Sparsification is achieved by reducing the amount of data in radar images to a list of potential targets and hypothetical targets, with removal of the radar images and lists from memory as soon as the accompanying data has been handled.

What is claimed is:

1. A moving target indicator radar system comprising:
a radar transceiver; and
processing circuitry coupled to the radar transceiver, the processing circuitry configured to:
provide a command to move an antenna beam in an azimuth direction;
control the radar transceiver to transmit a series of pulses throughout antenna beam motion such that the series of pulses are assembled into Coherent Processing Intervals (CPIs) and such that for a possible target, sequential sets of CPIs are combined covering at least a 3 dB portion an azimuth beam; and
detect at least one moving target in at least one CPI.

2. The moving target indicator radar system of claim 1, wherein the sequential sets cover the azimuth beam null-to-null.

3. The moving target indicator radar system of claim 1, wherein the processing circuitry is configured to:
steer the beam such that the beam moves to a new azimuth with each coherent processing interval (CPI); and
the circuitry comprises a set of processors and wherein each processor is configured to process one CPI independently of other processors of the set of processors and wherein each processor is configured to generate a range-Doppler map that includes target indications.

4. The moving target indicator radar system of claim 3, wherein each processor is configured to:
generate a list of detections from the range-Doppler map, the list including at least range and Doppler information, and CPI information for each detection; and
remove the range-Doppler map from memory subsequent to generating the list.

5. The moving target indicator radar system of claim 4, wherein the processing circuitry is configured to:
replicate elements in the list to a plurality of ambiguous range and Doppler locations to generate candidate CPI hypothesis lists at each processor;
combine the candidate CPI hypothesis lists from each processor of the set of processors; and
perform a clustering algorithm on the combined candidate CPI hypothesis lists to determine which hypotheses are true detections.

6. The moving target indicator radar system of claim 5, wherein the clustering algorithm includes determining a cluster of hypotheses in a three-dimensional space that has a largest total signal-to-noise ratio.

7. The moving target indicator radar system of claim 6, wherein the clustering algorithm comprises:
deleting hypotheses that are not true detections; and
searching to detect clusters of remaining hypotheses with the largest total signal-to-noise ratio.

8. A method comprising:
commanding an antenna beam to move in an azimuth direction;
controlling a radar transceiver to transmit a series of pulses throughout antenna beam motion such that the series of pulses are assembled into Coherent Processing Intervals (CPIs) and such that for a possible target, sequential sets of CPIs are combined covering at least a 3 dB portion of an azimuth beam; and
detecting at least one moving target in at least one CPI.

9. The method of claim 8, wherein the sequential sets of CPIs cover the azimuth beam null-to-null.

10. The method of claim 8, wherein the method further comprises:
steering the beam such that the beam moves to a new azimuth with each coherent processing interval (CPI);
processing one CPI independently on each processor of a set of processors; and
at each processor, generating a range-Doppler map that includes target indications.

11. The method of claim 10, further comprising:
generating a list of detections from the range-Doppler map, the list including at least range and Doppler information, and CPI information for each detection; and
removing the range-Doppler map from memory subsequent to generating the list.

12. The method of claim 11, further comprising:
replicating elements in the list to a plurality of ambiguous range and Doppler locations to generate candidate CPI hypothesis lists at each processor;
combining the candidate CPI hypothesis lists from each processor of the set of processors; and
performing a clustering algorithm on the combined candidate CPI hypothesis lists to determine which hypotheses are true detections.

13. The method of claim 12, further comprising:
determining a cluster of hypotheses in a three-dimensional space that has a largest total signal-to-noise ratio.

14. The method of claim 13, further comprising:
deleting hypotheses that are not true detections; and
searching to detect clusters of remaining hypotheses with the largest total signal-to-noise ratio.

15. A machine-readable medium including instructions that, when executed on a set of processors, cause the set of processors to perform operations including:
providing a command to move an antenna beam in an azimuth direction; and
controlling a radar transceiver to transmit a series of pulses throughout antenna beam motion such that the series of pulses are assembled into Coherent Processing Intervals (CPIs) and such that for a possible target, sequential sets of CPIs are combined covering at least a 3 dB portion of an azimuth beam; and
detecting at least one moving target in at least one CPI.

16. The machine-readable medium of claim 15, wherein the sequential sets of CPIs cover the azimuth beam null-to-null.

17. The machine-readable medium of claim 15, wherein the operations further include:
steering the beam such that the beam moves to a new azimuth with each coherent processing interval (CPI) or continuously; and
processing one CPI independently on each processor of a set of processors; and
at each processor, generating a range-Doppler map that includes target indications.

18. The machine-readable medium of claim 17, wherein the operations further comprise:
generating a list of detections from the range-Doppler map, the list including at least range and Doppler information, and CPI information for each detection; and
removing the range-Doppler map from memory subsequent to generating the list.

19. The machine-readable medium of claim 18, wherein the operations further comprise:
replicating elements in the list to a plurality of ambiguous range and Doppler locations to generate candidate CPI hypothesis lists at each processor;
combining the candidate CPI hypothesis lists from each processor of the set of processors; and
performing a clustering algorithm on the combined candidate CPI hypothesis lists to determine which hypotheses are true detections.

20. The machine-readable medium of claim 19, wherein operations further include:
determining a cluster of hypotheses in a three-dimensional space that has the largest total signal to noise ratio;
deleting ambiguous hypotheses;
and searching to detect a cluster of remaining hypotheses with the largest total signal to noise ratio.
